(19) United States
(12) Patent Application Publication
(10) Pub. No.: US 2012/0173302 A1
(43) Pub. Date: Jul. 5, 2012

(54) METHOD OF PROVIDING ECONOMETRIC INFORMATION BASED ON REAL TIME/REAL DATA FINANCIAL TRANSACTIONS

(75) Inventors: Todd Alan Dooley, Edina, MN (US); Charles Todd Joseph, Franklin, TN (US); Brian Lee Palmer, La Canada Flintridge, CA (US); Edward Emery Leamer, Los Angeles, CA (US)

(73) Assignee: CERIDIAN CORPORATION, Brentwood, TN (US)

(21) Appl. No.: 12/980,441

(22) Filed: Dec. 29, 2010

(51) Int. Cl. G06Q 10/00

(52) U.S. Cl. 705/7.29

(57) ABSTRACT

Econometric information is produced based upon real data that has been electronically acquired in real time. The acquired data is analyzed to select data records having attributes unique to a particular activity of interest. The selected data records are aggregated, adjusted, and used to create a statistical index or metric related to an economic activity. The statistical index or metric, together with information illustrating or interpreting information, is electronically distributed. As an example, a Pulse of Commerce Index related to shipment of goods is produced by electronically processing and storing data relating to financial transactions involved in purchase of goods and services. Data records are selected that involve fuel purchases, which act as a proxy for freight activity. Using the selected data records, both national and regional indices based upon fuel purchases are produced and distributed.

### BACKGROUND

Econometric information about the state of the US economy (as well as the global economy) is provided by both government agencies and private firms. The information is released at different times and different frequencies. Analysts and economists evaluate the information that is released, and provide their own interpretation and recommendations based upon the information. The media reports data, as well as opinions of the economists and analysts.

Econometric information is of interest to academic economists, who study how the economy functions. Wall Street analysts are also interested in econometric information so that they can make predictions and recommendations with respect to investment strategies and opportunities. Business managers and planners use econometric information in determining plans and strategies for businesses that are affected by the changes in economic conditions. Members of the public also receive econometric information and the interpretation of that information through the electronic and print media. This may be used by readers making decisions regarding financial investments, in making personal and career plans, and in forming political views.

The United States Department of Commerce provides information on a number of different economic indicators. For example, the Census Bureau provides monthly information such as: Advanced Monthly Sales for Retail and Food Services; Advanced Report on Durable Goods; Construction Put in Place; Manufacturer's Shipments; Inventories and Orders; Manufacturing and Trade: Inventories and Sales; Monthly Wholesale Trades; New Residential Construction; and New Residential Sales. The Bureau of Economic Analysis (BEA) provides monthly information on Personal Income and Outlays; and quarterly information on US International Transactions. The BEA also provides quarterly Gross Domestic Product (GDP) information. The Gross Domestic Product (GDP) is a basic measure of the economic output of a country. It is used, for example, by the White House and Congress in preparing budget estimates and projections. It is also used by the Federal Reserve in setting monetary policies, and by Wall Street analysts providing primary indicators of national economic activity. The business community also uses that information to plan financial and investment strategies.

The Federal Reserve produces the Industrial Production Index on a monthly basis. The Industrial Production Index is a measure of output in manufacturing, mining, and electric and gas utilities. In comparison, the GDP is a measure of market value of the goods and services produced by labor and property located in the United States. GDP values production in terms of prices paid by ultimate purchasers, such as consumers. The Industrial Production Index, on the other hand, values production in terms of the prices paid to manufacturers by wholesalers, retailers, or consumers (in the case of direct sales).

The Bureau of Labor Statistics provides information on inflation and prices (i.e. the Consumer Price Index and Producer Price Index), employment, unemployment, pay and benefits, productivity and cost.

In addition, there are a number of business firms that provide econometric information in the form of reports and indices. Examples include the ADP Employment Report, Kronos Retail Labor Index, ICSC-Goldman Store Sales, Redbook Retail Sales, and Case-Shiller Home Price Indices. In addition, other reports are generated through after-the-fact surveys such as Institute for Supply Management monthly report on business, Challenger Job Cuts, Mortgage Bankers Association, and consumer confidence surveys by the University of Michigan and the Conference Board.

Many of the reports and indices are based upon information obtained from surveys after the fact, and involve voluntary participation by businesses or trade associations. The data typically involves a sampling, rather than all data in a category. The release of the report or index typically involves a delay (i.e., it is not available on a real-time basis), and the report or index is often subject to revision after it is first released.

There is one type of information that is collected on a real-time basis, and based upon actual prices and volumes. That information involves trading of securities on the New York Stock Exchange, NASDAQ, and other exchanges in the US and internationally. Well known examples of stock indices include the Dow Jones Industrial Average and the S & P 500 Index. While this data from the financial sector is of wide interest, it represents only a shadow of the real economy. In other words, the prices and volumes of trades of stocks and bonds on Wall Street are not necessarily an indication of what is happening on “Main Street”.

### SUMMARY

Econometric information, such as indices and reports, is produced based upon fuel consumption data for over-the-road trucking that has been electronically acquired. This econometric information serves as an indicator of the current state and of the possible future direction of the US economy.

The econometric information is produced by acquiring and storing data records representing financial transactions that involve purchases of goods and services, including fuel purchases. The data records are analyzed to select only those records having attributes related to a particular activity of interest (trucking). The attributes may include, for example, number of gallons, zip code, date, transaction price, and state. From those selected records, the attributes of interest are aggregated and used to create a statistical index or metric related to economic activity. The statistical index or metric is then electronically distributed.

### BRIEF DESCRIPTION OF THE DRAWINGS

FIGS. 1A and 1B are block diagrams illustrating a system and method for producing econometric indices and reports based upon real-time financial transactions involving fuel purchases, which act as a proxy for freight activity.

FIGS. 2A and 2B are graphs of monthly diesel fuel purchases (tractor gallons) and an unadjusted Pulse of Commerce Index (PCI) based upon tractor gallons normalized to 2002, respectively.

FIG. 3 is a graph showing diesel fuel gallons purchases by day of the week from 1999 through 2009, indexed to Wednesday=100.

FIG. 4 is a graph showing the number of workdays by month from January 1999 through February 2010.

FIG. 5 is a graph showing seasonally adjusted PCI with and without workday adjustment.

FIG. 6 is a graph showing monthly variation of the unadjusted PCI for each year from 1999 through 2009 illustrating seasonal patterns of the index.

FIG. 7 is a graph of the unadjusted PCI and the adjusted PCI from 1999 through 2009.

FIG. 8 shows the unadjusted PCI, adjusted PCI and smoothed adjusted PCI from 1999 through 2009.

FIG. 9 is a graph showing seasonally and workday adjusted PCI and smoothed (three-month moving average) seasonally and workday adjusted PCI from January 2006 through February 2010.

FIG. 10 is a graph showing year over year growth in the seasonally and workday adjusted PCI from January 2006 through February 2010.

FIG. 11 is a graph showing smoothed adjusted PCI, Industrial Production Index, and Retail Sales Index from 1999 through 2009.

FIG. 12 is a graph showing smoothed adjusted PCI and GDP compared to peak levels from 1999 through January 2010.

FIG. 13 is a graph showing smoothed adjusted PCI and the components (goods, services, and structures) of GDP compared with peak levels from 1999 through January 2010.

FIG. 14 is a graph showing smoothed adjusted national and regional PCI from 1999 through 2009.

### DETAILED DESCRIPTION

At every minute of every day, trucks are rolling across America laden with goods. Measuring the flow of these trucks can provide a view into the health of the economy, just as a doctor measures the flow of blood by checking a patient's pulse as part of an examination of a patient's health.

The interstate highways that crisscross America are the arteries along which flow the products that are the life blood of the US economy. Ceridian Corporation, the assignee of the present application, is a payment services provider to various transportation and other industries, including trucking through its subsidiary Comdata Network, Inc. d/b/a Comdata Corporation. The Comdata network processes electronic card payment transactions involving, for example, debit and credit cards, and proprietary fleet cards. The cards processed include proprietary (or “closed loop”) cards provided by Comdata for use at locations that have agreed to accept Comdata cards, as well as “open loop” Comdata/MasterCard cards that can be used at any location that accepts either Comdata or MasterCard cards. The Comdata network processes transactions involving the Comdata proprietary cards as well as Comdata/MasterCard cards. Merchants accepting the Comdata proprietary cards include service stations, truck stops, and convenience stores. In addition, there are MasterCard locations worldwide at which the Comdata/MasterCard cards are accepted.

The purchase of fuel used by trucks, particularly diesel fuel purchases, in effect provides a sensing of trucking activity throughout the United States. Less than a second after a Comdata card is swiped at a truck stop to authorize the purchase of diesel fuel, that transaction is recorded by computers at the Comdata data center. The data that is collected is real data that is acquired in real-time. This is in contrast to data typically used to track the economy that are based on after the fact surveys filled out by individuals who may have varying incentives to provide accurate information.

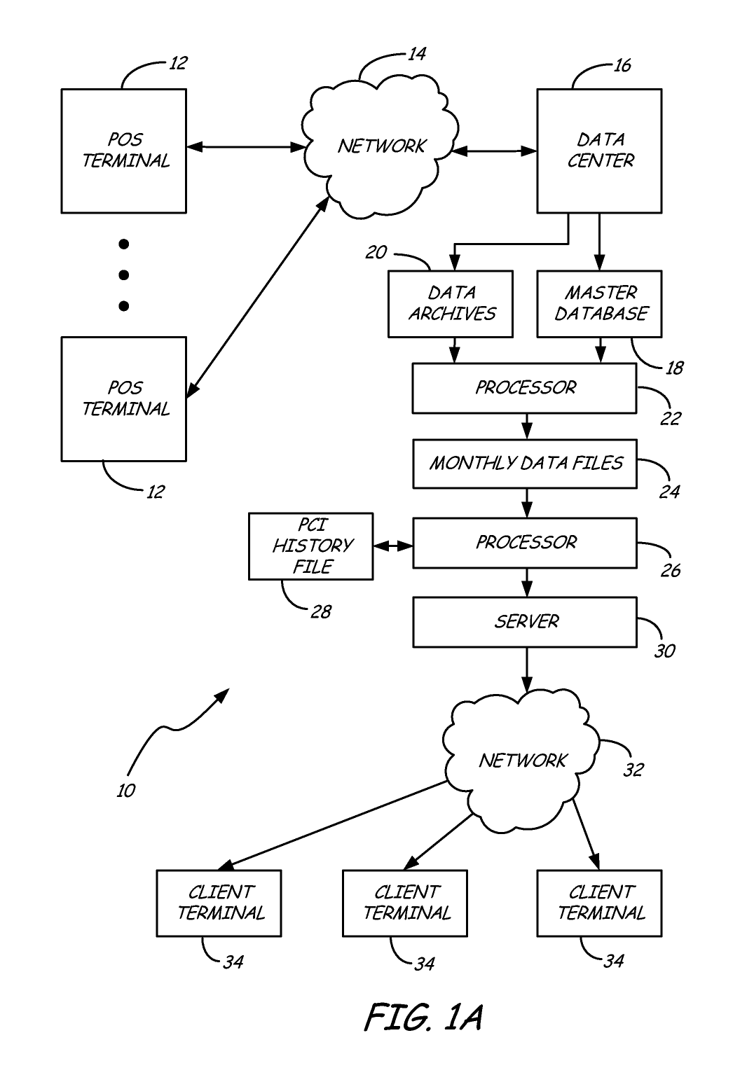

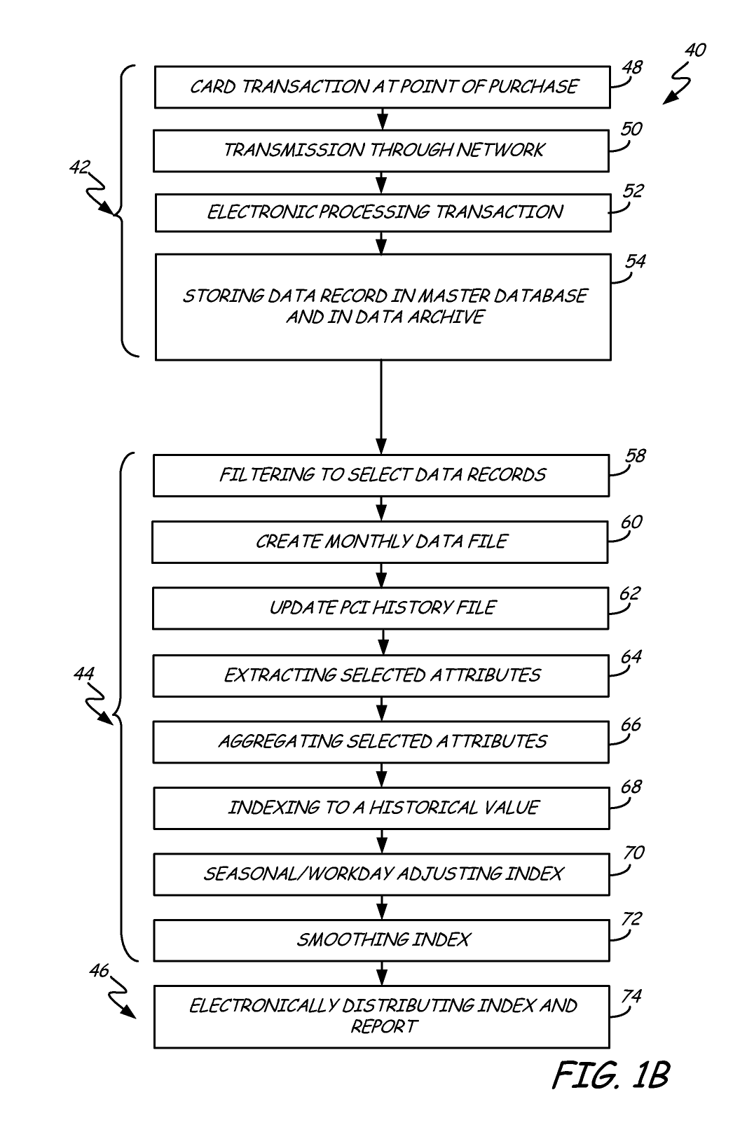

FIG. 1A is a block diagram illustrating a system for producing an index and other related econometric information based on hard purchases. System 10 includes point of sale terminals 12, network 14, data center 16, master database 18, data archives 20, processor 22, monthly data file 24, processor 26, PCI history file 28, server 30, network 32, and client terminals 34.

Point of sale terminals 12 are located at service stations, truck stops, convenience stores, and other locations where the purchase of goods and services, including purchase of fuel, is made. Point of sale terminals 12 communicate through network 14 to data center 16. Processing of electronic card payment transactions are performed at data center 16. Each transaction processed by data center 16 has a data record that is stored initially in master database 18. Subsequently, data records are stored in data archives 20, so that the data can be maintained over an extended period of time.

Processor 22 creates monthly data files 24 from the data records obtained from master database 18 and data archives 20. The data records are filtered to select only data records containing purchase of fuel in the continental United States. The selected data records are sorted and summarized by certain attributes to create monthly data file 24 for the month of interest.

Processor 26 performs a series of processing steps on the data records in monthly data file 24 using a set of business rules and logic to perform data manipulation. Processor 26 may, for example, perform data extraction, and aggregating of selected attributes (or data fields) of the data records. Processor 26 then uses the aggregated attribute data to produce national or regional smoothed and adjusted Pulse of Commerce Indices, as well as other related information.

Monthly data files 24 as well as PCI data generated by processor 26 may be stored in PCI history file 28. This allows processor 26 to access the data needed to update or make adjustments to the PCI, such as at the end of a calendar year.

Server 30 electronically distributes the smoothed and adjusted PCI and an accompanying report over network 32 to client terminals 34. Network 32 may include the internet, private networks, or both.

FIG. 1B is a diagram illustrating the process of producing an index and other related econometric information based upon card purchases, which acts as a proxy for over-the-road transportation of goods. Process 40 includes three major portions: data acquisition 42, data processing 44, and electronic distribution 46. Process 40 may be performed by system 10 of FIG. 1A, and reference will be made to system 10 while describing process 40.

Data acquisition 42 includes steps 48, 50, 52, and 54. It begins with a transaction at a point of purchase (POS terminal 12) involving a credit card, debit card, or other electronic transactions involving a company or other customer having an account serviced by data center 16 (step 48). For example, the card involved may be a proprietary (closed loop) Comdata card, or may be an open loop Comdata/MasterCard card accepted by the MasterCard network. The purchase can involve a wide variety of goods and services provided at truck stops and service centers. Data acquisition 42 may also include fuel purchases that do not involve a card or are not processed in real-time (e.g. transactions that are batch processed). Examples include, mobile fueling which involves delivery of diesel fuel to a trucking company terminal or fleet lot, and terminal fueling in which a mobile fueler fuels trucks at a trucking company terminal or fleet lot after working hours and replenishes the bulk fuel supply in the company's onsite tanks.

Upon scanning of the card, or entry of the account number associated with that card, information regarding the transaction is transmitted through network 14 (step 50). As an example, if a Comdata proprietary card is used, then transmission occurs through the proprietary Comdata network to the Comdata data center. If the transaction is conducted using a Comdata/MasterCard at a site that has not agreed to accept Comdata proprietary cards, then the MasterCard network acts as a gateway in the transmission of the transaction data to data center 16.

Once the transaction data has been received at data center 16, electronic processing of the transaction takes place (step 52). This includes verifying that the transaction is authorized, and communicating that information back through network 14 to the point of purchase.

For each transaction that is processed, a data record is created and stored initially in master database 18 and subsequently in data archives 20 (step 54). Each data record includes a number of attributes or data fields relating to that particular transaction. In one example, 45 to 50 different attributes or data fields are contained in the data record for each transaction. The data is maintained over an extended period of time in data archives 20. For example, with the data used to produce the Pulse of Commerce Index (PCI) that will be described involved data records for all transactions from 1999 to present. The length of the period covered by data archives 20 will, of course, depend upon the current and potential future uses of that data, as well as record keeping requirement of customers and governmental entities. Data archives 20 contain billions of data records representing electronically processed transactions of which some, but not all, involve the purchase of fuel used in transporting goods.

Data acquisition portion 42 of method 40 involves real transaction data that is processed in real-time. Transaction data is inherently more accurate than data derived from after the fact surveys. Many of the leading indices generated by the US government and private businesses rely upon data from after the fact surveys.

Data processing portion 44 of method 40 includes steps 58, 60, 62, 64, 66, 68, 70, and 72. It uses data records stored in master database 18 and/or uses data records restored from data archives 20 to generate a national level Pulse of Commerce Index and regional Pulse of Commerce Indices on a monthly basis. The regional indices are based upon the nine regions of the contiguous 48 states as defined by the US Census Bureau: Pacific, Mountain, West North Central, East North Central, West South Central, East South Central, South Atlantic, Middle Atlantic, and New England. Data processing portion 44 can also be used to generate indices and other econometric information for individual states, different areas within a particular state, or even specific localities defined by zip codes or groups of zip codes. Custom reports can also be run on different frequencies than the national and regional Pulse of Commerce Indices. Depending on needs, the time periods of interest can be quarterly, monthly weekly or even daily.

As stated above, master database 18 and data archives 20 contain data records for transactions over an extended time period, and include all transactions for all types of goods and services purchased. Only some of those data records contain information about fuel purchases within a time period of interest. Monthly data files 24 are created using data records from master database 18 and/or data archives 20 covering a time period of historical interest.

In processing portion 44, data reduction takes place to reduce the total contents of master database 18 or data archives 20 to a data set containing only the information (attributes) of interest from the data records of interest. This data reduction by processor 22 and 26 is achieved by launching a set of business rules and logic to perform a series of processes of filtering (step 58) data extraction (step 64), and aggregating (step 66).

When monthly national and regional Pulse of Commerce Indices are to be generated, a filtering process is first performed to select data records of interest (step 58). Filtering is performed based upon attributes (or data fields) contained within the data records stored in master database 18 (or data archives 20). Although each data record contains 45 to 50 different attributes, there are particular attributes that are of importance for filtering step 58. These include the transaction date; an account code; a merchant code that identifies the particular merchant at which the transaction took place; a merchant state in which the merchant where the purchase took place is located; a product ID that identifies the transaction by product type; a total number of transactions per group; the total number of diesel fuel gallons only purchased; the total cost for the diesel fuel gallons in this transaction group; and an average fuel cost calculated from the total number of gallons and total cost.

The filtering (step 58) selects only data records in which the diesel gallon attribute is greater than zero. The filtering also selects only data records for a specific time period, e.g. the most recent month. This filtering reduces the data records from hundreds of millions of transactions on an analyzed basis to millions of transactions. The records are then sorted and summarized by transaction date, account code, merchant code, merchant state, and product ID to create the monthly data file for the month of interest (step 60). In addition, PCI history file 28 is updated to include the latest monthly data file (step 62).

Depending upon the particular time period of interest and the particular geographical scope of interest (national, regional, or state), the data records in the monthly data file can be further filtered to reduce the number of records. Unnecessary data is then removed from the data records of interest at step 64. This involves extracting those attributes of interest to the particular index or other econometric information that is being generated. In producing the Pulse of Commerce Indices, only a limited number of attributes or data fields are needed. These attributes must be unique to the particular activity being monitored. In this case, the activity is purchases of diesel fuel, which acts as a proxy for over-the-road shipments. As part of the removal of unneeded data, any identification of a particular customer is removed, as is the identification of a particular merchant. The attributes that are extracted include number of gallons; number of transactions; zip code; date; transaction price for purchase of the gallons of diesel fuel; and state of the merchant.

Upon extracting the attributes of interest, the data records containing only the attributes of interest are added to a data bucket. At this point, the data records contained in the bucket can be checked, for example, for outliers that may be unreliable data.

To produce an index, selected attributes are aggregated to create a data set relating to fuel purchases within the particular time period of interest (step 66). The total number of diesel fuel gallons sold with each month in all 48 contiguous states is generated for the national PCI. Similarly, the total number of diesel fuel gallons sold in each region is generated for each regional PCI.

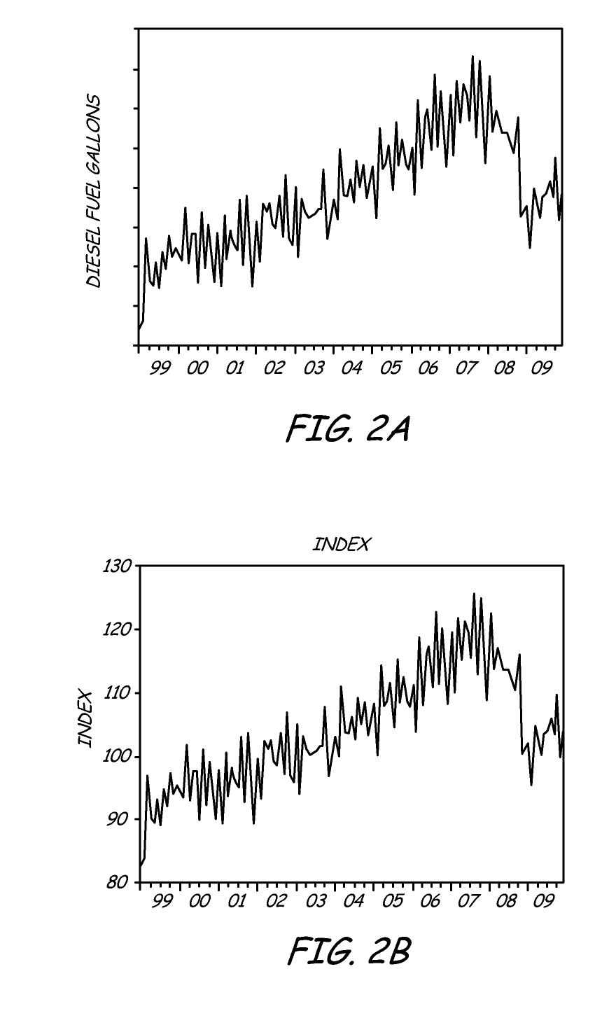

FIG. 2A shows a graph of diesel fuel gallons sold nationally per month from 1999 through 2009. This data is then converted into a raw index shown in FIG. 2B (step 68). The diesel fuel gallons sold (FIG. 2A) are indexed to a historical value: the monthly average of diesel fuel gallons sold in 2002, which are set as an index value of 100. Historical values used for many current U.S. government provided indices are based on 2002 information.

Once a raw or unadjusted index has been created by dividing the amount of diesel fuel gallons purchased in each month by the average amount purchased in 2002, a series of adjustments (step 70) and smoothing (step 72) of the index is performed. One area of potential concern when analyzing changes in data series is the extent to which the observed changes are due to movement in what is being measured versus changes due to sample selection. For example, changes in volume purchases can be due to accounts (customers) that are entering or leaving the data pool during the time period of interest. This can also be referred to as births and deaths.

Determining the birth or death of an account can be complicated by a number of factors. First, identifying that an account is no longer in the sample does not necessarily mean that the account died. The departing account could have merged with another account, and all information about its transactions would still be captured in the data. Second, not all accounts make purchases in every month, and therefore there is a potential that deaths of accounts for the most recent months may be overstated.

To examine the potential impact of an account entering or leaving the data, a net change amount was calculated using average purchases over the time period when the account was in the sample. Thus a net birth/death amount for each month was calculated as the total of the average purchases for the accounts entering the sample in that month minus the total average purchases to the accounts leaving the sample for that month. The net change amount was then subtracted from the raw total to get an estimate “status quo” level. A birth/death adjusted index was then compared to the raw or unadjusted index over the period 1999 through 2009. Results of the comparison show that the impacts of births/deaths appear to be small, and that observed changes in the PCI appear to be driven by changes in the underlying data and not due to sample selection events. Thus, a birth/death adjustment can be made, but does not appear to be necessary.

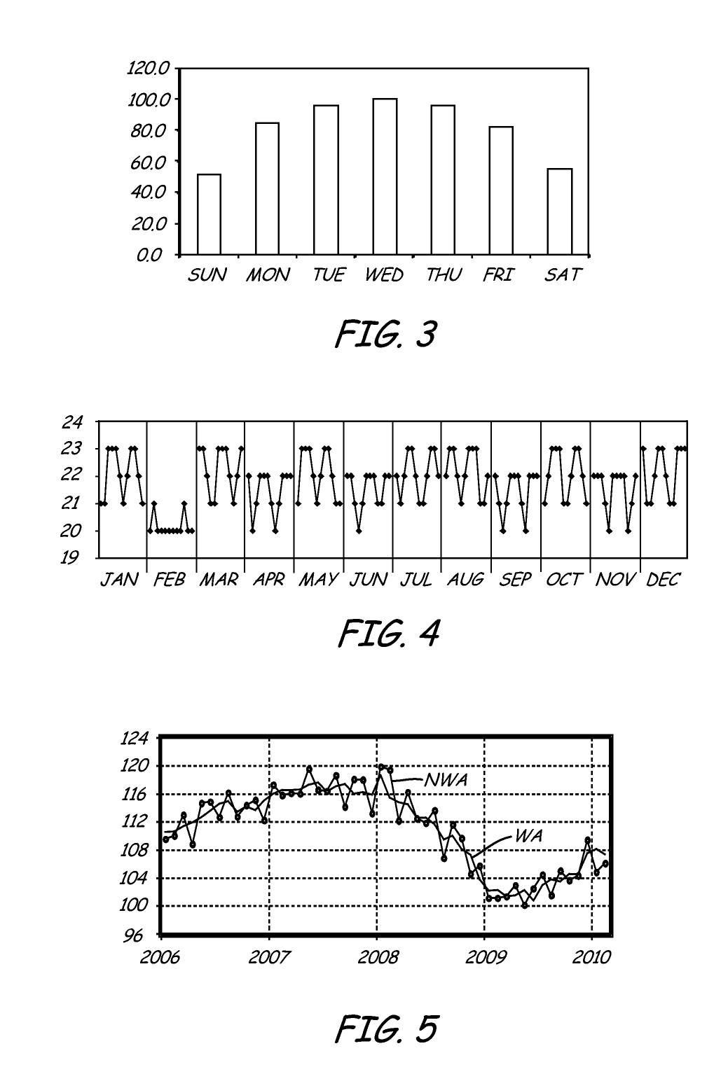

One adjustment that can be made is a workday adjustment, which reflects a monthly adjustment for workdays and weekends. FIG. 3 is a graph showing tractor gallon purchases by day of the week from 1999 through 2009. FIG. 3 shows that diesel fuel purchases are greatest in the middle of the work week, with Wednesday being the highest day of purchases. The level of purchases is only half as large on Saturday and Sunday. Traditional seasonal adjustment methods would correct for this difference if the number of workdays each month were constant. However, the number of workdays in a given month varies because of changes in the day of the week for the first day of the month. A number of workdays in each month from 1999 to 2010 is illustrated in FIG. 4. January and December workdays vary from 21 to 23. December 2009 has the greatest number of workdays (23) and January 2010 has the fewest (21).

A workday adjustment removes a substantial amount of month-to-month irrelevant variation in the PCI. This is illustrated in FIG. 5, which displays seasonally adjusted data with or without a workday adjustment. The curve labeled NWA with circle symbols at each month is a series of PCI monthly values that have been seasonally adjusted, but have not had workday adjustment. A curve labeled WA shows the PCI monthly index value from January 2006 through February 2010 with a workday adjustment. Notice the sharp decline in the NWA curve from December 2009 to January 2010. At the same time, curve WA rose from December 2009 to January 2010. In other words, all of the decline from December 2009 to January 2010 in the seasonally adjusted PCI, and a little bit more, was due to a decline in workdays from December to January, and not a fundamental decline in trucking activity.

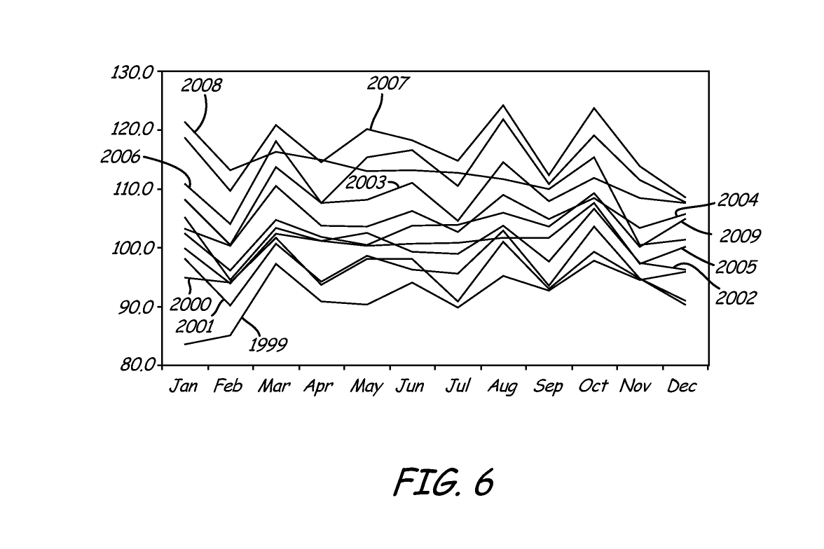

As shown in FIG. 6, there is a strong seasonal pattern in the national PCI. The method used to adjust the PCI is the Census Bureau's X-12 adjustment process. The X-12-ARIMA process is a full sample method, i.e. it both uses and adjusts all available data. To preserve consistency in the historical data and prevent the possibility in a slight change in a historical seasonally adjusted index values, adjustment of the historical numbers is performed annually, and the monthly adjustment factors from the most recent full year is used for the upcoming year. Once an additional full year of data becomes available (in January of each year) the entire series is re-estimated, which will adjust all of the historical data and will also provide seasonal adjustment factors for the coming year.

Seasonal adjustments differ from region-to-region. Therefore, the PCI for each individual region is seasonally adjusted using the adjustment parameters associated with that particular geographic region.

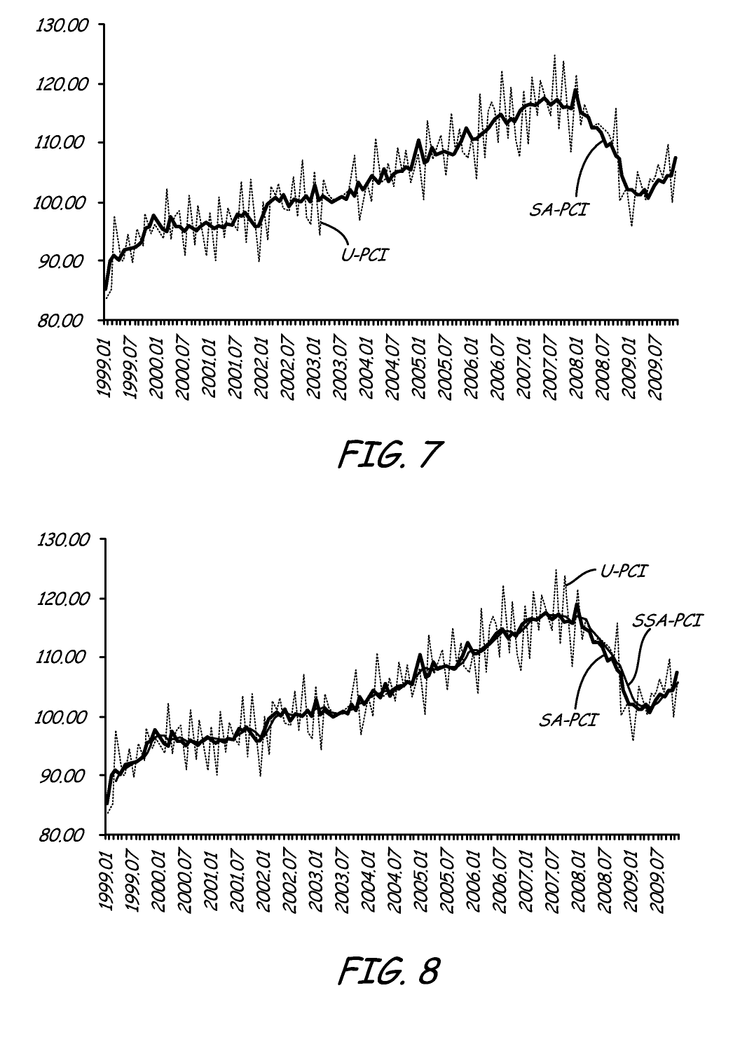

FIG. 7 shows the unadjusted raw national index U-PCI and the seasonally and workday adjusted index SA-PCI for 1999 through 2009. The overall shape of the PCI is the same in both its unadjusted and adjusted form. The unadjusted monthly values, however, have more variability.

Besides seasonal adjustment, a three month moving average can be used to smooth the seasonally adjusted index. Smoothing not only gives a clearer picture of longer term trends, but since over-the-road trucking is not constant for each day of the week (there are also cycles among days of the week), the divisions of monthly periods occurs at different intervals (i.e. different days of the week) which causes the monthly division by itself to induce some monthly variations.

FIG. 8 is a chart showing the unadjusted index UPCI, seasonally and workday adjusted index SA-PCI, and the smoothed seasonally and workday adjusted index SSA-PCI.

The final portion of method 40 is distribution of the econometric information that has been generated by method 40. At step 74, the national and regional Pulse of Commerce Indices as well as related econometric information and analysis are electronically distributed. In one embodiment, the information is provided on a website hosted by server 30, and includes not only the indices, but also analysis and explanation of the indices and what they show. The information is also provided (e.g. by server 30) for distribution through television, radio, and the print media. The distribution of the index may include a report providing an interpretation and analysis of the index. The index may also be compared or tied to other measures (other metrics and indices) in the report to provide a more detailed analysis and interpretation. Similarly, custom indices and reports generated at customer request are also distributed electronically, for example by email or by a user-restricted access through a website.

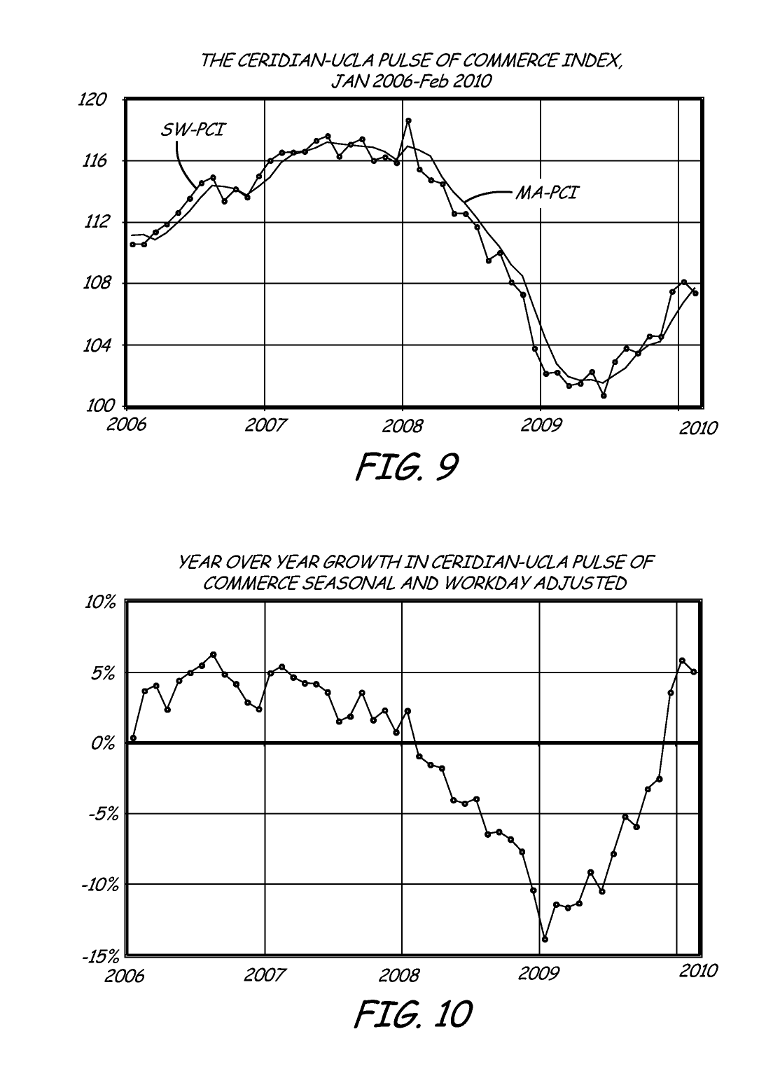

FIG. 9 is a graph showing the seasonally and workday adjusted index SA-PCI, and a three month moving average of that adjusted index SSA-PCI from 2006 through February, 2010. The graph in FIG. 9 shows that the US economy was essentially flat over the first two months of 2010, with a February decline offsetting modest gains reported for January. With both seasonal and workday adjustments reflected, the PCI for February fell 0.7%, following January's increase of 0.6%. The flat performance for the first two months of 2010 followed a 2.8% gain in December, 1999.

The PCI is adjusted for seasonality, but not for unusual events, such as the record February, 2010 snowfalls in the East North Central and Mid Atlantic regions, which experienced PCI declines of −4.1% and −2.5%, respectively. In other parts of the country, the PCI was growing rapidly in February, up 2.7% in the West North Central region, 2.6% in the West South Central region, and 2.1% in the Pacific region. This information shows the value of the regional PCI as well as the national PCI.

Another way to view the PCI is with a year-over-year growth analysis. FIG. 10 shows the year-over-year change in the PCI from January 2006 through February 2010. In FIG. 10, the seasonal and workday adjusted PCI for each month was compared to the similar value for the same month a year earlier, and a percent change was calculated. As seen in FIG. 10, after almost two years in the red, the year-over-year change in the PCI became positive with a large increase in December 2009. The January and February 2010 PCI values have produced a slightly larger year-over-year change of about 5%. These rates of increase are approximately normal level, although not the 10% to 15% rates that would be produced in a recovery strong enough to put Americans back to work.

The utility of the Pulse of Commerce Index will depend on how well it tracks, and in some times predicts information provided by other economic indicators. One bench mark as to the potential value of the unique information available from the PCI is to compare the PCI with other well known indices. Two particular indices that would seem to be closely related with the movement of products around the country are industrial production and retail sales.

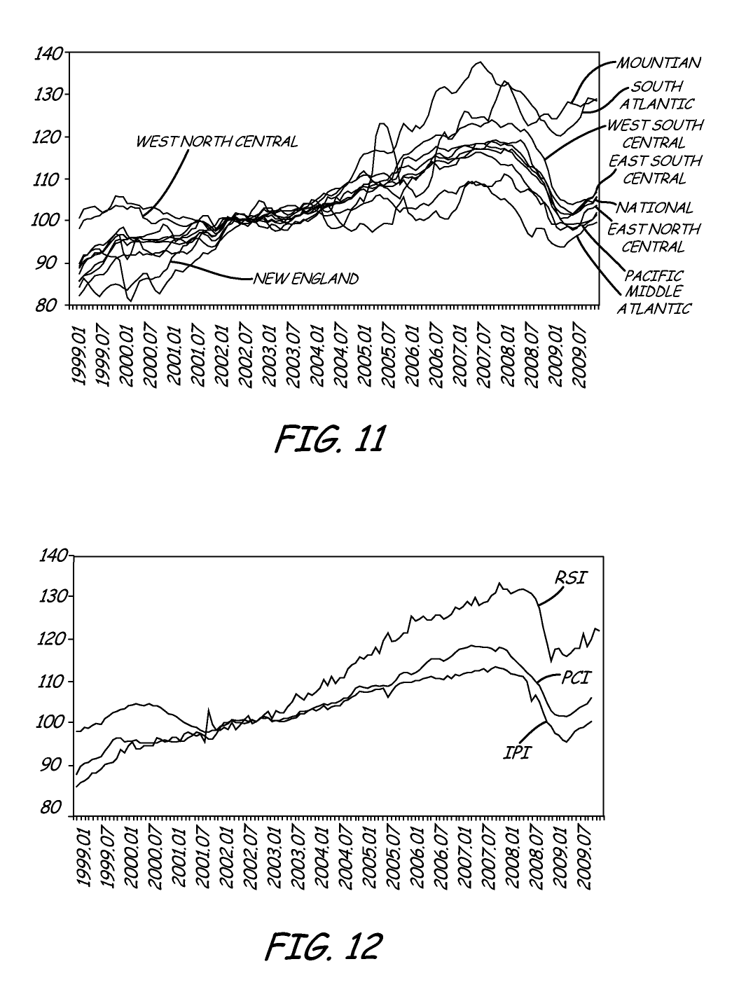

FIG. 11 is a chart showing smoothed seasonally and workday adjusted Pulse of Commerce Index (PCI), seasonally adjusted Industrial Production Index (IPI) and seasonally adjusted Retail Sales Index (RSI). It is apparent when reviewing FIG. 11 that smoothed adjusted PCI and Industrial Production generally moves closely together, with a notable exception that the smoothed adjusted PCI tends to lead the Industrial Production Index. In the most recent recession, the substantial decline in the smoothed adjusted PCI began before the decline in IPI, and the smoothed adjusted PCI turned around and started increasing before IPI increased. In the recession of 2001, on the other hand, smoothed adjusted PCI and IPI behaved differently.

Comparing the PCI to the Retail Sales Index (RSI) indicates that the PCI started a substantial decline before RSI. During the 2001 recession, however, RSI and the PCI tracked each other quite closely. One explanation for the difference in the way the indices moved during the most recent recession in contrast with the recession of 2001 is that in 2001 there was a greater impact on business than consumers. Hence, the over-the-road movement of products for the RSI continued to move forward.

Because the smoothed adjusted PCI is based upon real data that is collected in real time, it has the potential of being delivered earlier than other indices, such as Industrial Production and Retail Sales. The Ceridian/UCLA PCI is released on about the 10^{th} day of each month, while the Retail Sales Index is released a few days later. Industrial production is typically released on about the 15^{th} day of each month. Using the smoothed adjusted PCI, it is possible to forecast growth of industrial production nearly a week before the Industrial Production Index is released. Once more, the smoothed adjusted PCI is based upon real data collected in real time, while the Industrial Production Index is based upon data gathered from surveys, and is revised based upon subsequently obtained information.

FIG. 12 shows a graph of real Gross Domestic Production (GDP) and PCI (seasonally and workday adjusted) around their peaks for a period from 1999 to early 2010. Over the decade since 1999, real GDP and smoothed adjusted PCI have grown at very similar rates, but the smoothed adjusted PCI experienced an early and amplified decline in the recession of 2008-2009. “Early” and “amplified” are the two essential features of a useful leading indicator.

FIG. 12 reveals that real GDP bottomed out in the second quarter of 2009, 3.8% below its peak value that occurred a year earlier in the second quarter of 2008. The smoothed adjusted PCI bottomed out in the same quarter, but 13.4% below its peak value, which occurred in the second quarter of 2007.

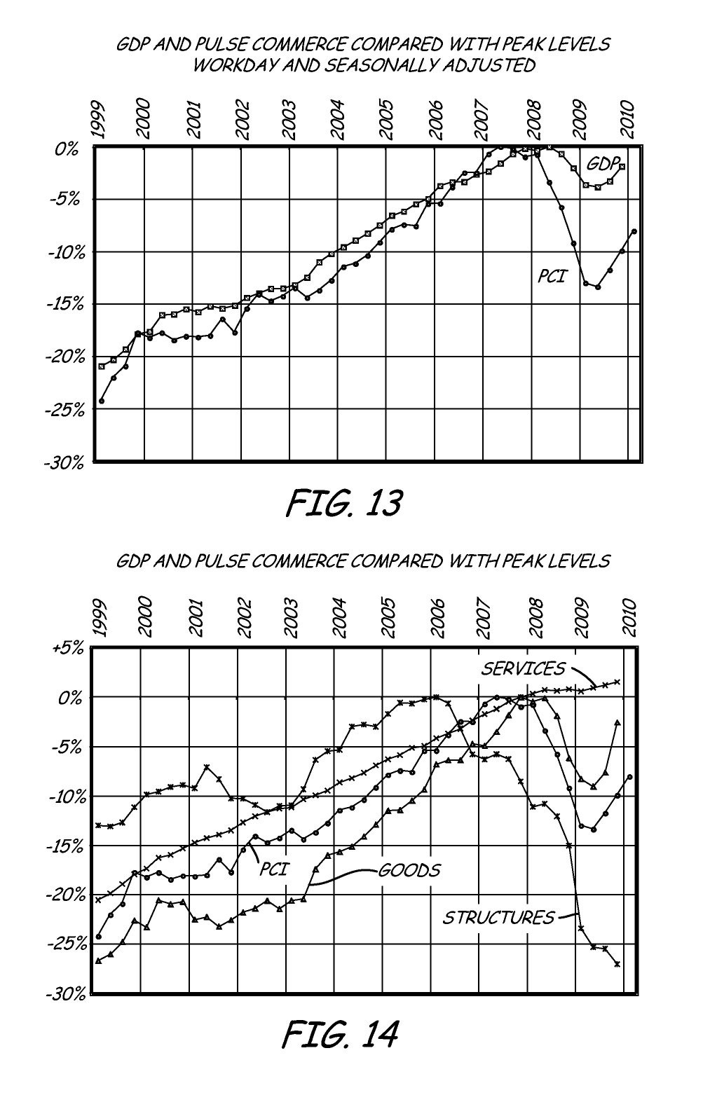

To understand why the smoothed adjusted PCI declined more than three times as much as GDP, it is necessary to look at the three components of GDP (Goods, Services, and Structures) in the graph shown in FIG. 13. Services, which comprise 63% of GDP, never seemed to decline throughout the entire period from 1999 through 2009. The volatility is in Goods and Structures—the 37% of GDP that typically gets loaded onto trucks. The smoothed adjusted PCI lies between the Goods component and the Structures component of GDP. This is what a leading indicator ought to do—concentrate on volatile components of GDP that are the main reasons for economic downturns.

In addition to the smoothed adjusted PCI at the national level, smoothed adjusted PCI is also delivered at a regional level for each of the nine census divisions. Each of the nine regional level series are individually seasonally adjusted using the Census Bureau X-12-ARIMA adjustment process to allow for different seasonal patterns in each region. They are also workday adjusted and smoothed using a three month moving average. This is the same smoothing process used for the national level data. FIG. 14 is a chart plotting the smoothed seasonally and workday adjusted PCI for each of the census regions, as well as for all regions combined. The chart, shown in FIG. 14, shows that there are some large differences in the smoothed adjusted PCI for different regions over time.

The method of the present invention defines econometric information that is important, reliable, timely, and valued. Without the movement of goods, there cannot be economic growth. The Pulse of Commerce Index, which is related to over-the-road shipments, provides an indication of the movement of goods. Purchases of fuel by the trucks that carry the shipment of goods provides important indication of what is happening in the US economy.

Unlike many of the widely used economic indicators, the data underlying the Pulse of Commerce Index is based upon real transactions that are processed in real time. The use of real data acquired in real time is more reliable than after the fact written or telephone surveys. Furthermore, the comparison of Pulse of Commerce Index to other widely accepted economic indicators show the reliability of the smoothed adjusted PCI.

The data acquired by processing financial transactions that involve purchase of goods and services (including fuel purchases) is unique. The data set has the rich geographic detail, including detail regarding truck stops on the interstates. Furthermore, the data acquired is used for processing real financial transactions, and the data collected is extensive (about 45 to 50 data fields or attributes for each transaction). This provides a wide range of attributes that can be selected to uniquely identify a particular activity of interest, such as diesel fuel sales for over-the-road trucking or gasoline sales to fleets of trucks that deliver airfreight packages. Through the use of different business rules and logic, different filtering and attribute selection can be used to create a powerful set of data from which econometric information can be derived and electronically distributed to parties of interest.

Although the particular example discussed with respect to FIGS. 1A and 1B has focused on purchase of diesel fuel as an indicator of movement of goods in commerce, other transactions can be included to provide further indication of shipment and goods through other channels such as airfreight, and rail freight. In particular, some major airfreight companies use local fleets of trucks that typically use gasoline rather than diesel fuel. By defining the business rules and logic used for filtering data records and extracting attributes of interest, a profile of transactions involving gasoline purchases that are related to movement of goods by airfreight can be identified in a similar way. A separate index, or an index using combined data of both diesel fuel sales and gasoline sales related to airfreight could be created. A similar process could be performed to capture information relating to movement of freight by rail. Once again, business rules and logic used for filtering and attributes extraction to create the bucket of data used to create the index need to be tailored to uniquely identify the activity of interest.

The econometric information provided with the method of the present invention provides a timely measure of the US economy. Within a second after a credit card is swiped, the transaction is authorized and recorded at data center 16. Only financial data involving trades of stocks and bonds is recorded at this frequency. Not only does this allow the national and regional smoothed adjusted Pulse of Commerce Indices to be distributed in advance of both the retail sales index and the industrial production index, but it also allows even faster or more frequent reporting of data to customers having a need for information sooner.

The econometric information provided by the method of the present invention is valuable in helping to predict recessions and recoveries. It can also be used to help predict later released indices and indicators, such as the Industrial Production Index.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of providing an index related to shipment of goods, the method comprising:
electronically processing financial transactions involving purchases;
storing, for each transaction, a data record having a plurality of attributes;
filtering the data records to select data records relating to transactions involving fuel purchases;
extracting selected attributes relating to fuel purchases from the selected data records;
aggregating the selected attributes to create a fuel purchase total;
indexing the fuel purchase total to a historical reference point to produce an index; and
electronically distributing the index.

2. The method of claim 1 and further comprising:
adjusting the index.

3. The method of claim 2, wherein adjusting the index comprises:
workday adjusting the index.

4. The method of claim 2, wherein adjusting the index comprises:
seasonally adjusting the index.

5. The method of claim 2 and further comprising:
smoothing the adjusted index.

6. The method of claim 5, wherein smoothing the index comprises forming a moving multi-month average of fuel purchases for each month represented by the index.

7. The method of claim 1, wherein the attributes include geographic information.

8. The method of claim 7, wherein the index comprises a regional index based upon the geographic information.

9. The method of claim 1, wherein the index comprises a national index.

10. The method of claim 1, wherein the fuel purchases include purchases of diesel fuel.

11. The method of claim 1, wherein the fuel purchases include purchases of gasoline by airfreight delivery companies.

12. The method of claim 1, wherein the financial transactions are card payment transactions.

13. The method of claim 1, wherein the selected attributes comprise: number of gallons, zip code, date, transaction price, and state.

14. The method of claim 1, wherein electronically distributing the index includes providing text and graphical material containing an interpretation of the index.

15. A method of providing an econometric index, the method comprising:
forming a database of data records representing card payment transactions;
analyzing the data records to select only those data records having attributes related to fuel purchases;
aggregating attributes related to the fuel purchases to create an index of the activity indexed to a historical value; and
electronically distributing the index.

16. The method of claim 15, wherein the attributes comprise tractor gallons data representing a number of diesel fuel gallons purchased.

17. The method of claim 15, wherein the selected attributes comprise: number of gallons, zip code, date, transaction price, and state.

18. The method of claim 15 and further comprising:
seasonally adjusting the index.

19. The method of claim 15 and further comprising:
workday adjusting the index.

20. The method of claim 15 and further comprising:
smoothing the index.

21. The method of claim 20, wherein smoothing the index comprises forming a moving multi-month average of fuel purchase for each month represented by the index.

22. The method of claim 15, wherein the attributes include geographic information.

23. The method of claim 22, wherein the index comprises a regional index based upon the geographic information.

24. The method of claim 15, wherein the index comprises a national index.

25. A system for providing an index related to shipment of goods, the system comprising:
a data center that electronically processes financial transactions involving purchases;
data storage that stores, for each transaction, a data record having a plurality of attributes;
one or more processors that filter the data records to select data records relating to transactions involving fuel purchases, extract selected attributes relating to fuel purchases from the selected data records, aggregate the selected attributes to create a fuel purchase total, and index the fuel purchase total to a historical reference point to produce an index; and
a server that electronically distributes the index.

26. The system of claim 25 wherein the one or more processors seasonally adjust the index.

27. The system of claim 25 wherein the one or more processors workday adjust the index.

28. The system of claim 25 and wherein the one or more processors smooth the index by forming a moving multi-month average of fuel purchases for each month represented by the index.

29. The system of claim 25, wherein the selected attributes extracted by the processor comprise: number of gallons, zip code, date, transaction price, and state.

30. The system of claim 25, wherein the server electronically distributes the index by providing over a network text and graphical material containing an interpretation of the index.

31. A system of providing an econometric index, the system comprising:
a database of data records representing card payment transactions;
one or more processors that analyze the data records to select only those data records having attributes related to fuel purchases, and aggregate attributes related to the fuel purchases to create an index of the activity indexed to a historical value; and
a server that electronically distributes the index.

32. The system of claim 31, wherein the attributes comprise tractor gallons data representing a number of diesel fuel gallons purchased.

33. The system of claim 31, wherein the selected attributes comprise: number of gallons, zip code, date, transaction price and state.

34. The system of claim 31, wherein the one or more processors seasonally adjust the index, workday adjusts the index, and smoothes the index.
